(19) United States
(12) Patent Application Publication
(10) Pub. No.: US 2003/0215771 A1
(43) Pub. Date: Nov. 20, 2003

(54) Autonomous weapons system simulation system for generating and displaying virtual scenarios on board and in flight

(76) Inventors: Klaus H. Bartoldus, Muenchen (DE); Dietrich Hartung, Muenchen (DE); Herbert Eibl, Unterhaching (DE); Juergen Boehm, Unterhaching (DE); Martin Grieb, Hoehenkirchen (DE); Hans Pongratz, Taufkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/413,569

(22) Filed: Apr. 15, 2003

(30) Foreign Application Priority Data
Apr. 15, 2002 (DE) 102 16 599.8

(51) Int. Cl. G09B 19/00

(52) U.S. Cl. 434/14

(57) ABSTRACT

An autonomous weapons system simulation is generated on board an aircraft and in flight, displaying virtual scenarios with a simulation of weapons systems on board the aircraft and computer-generated ground-to-air and air-to-air threats. The weapons system simulation system permits a real-time air combat training on board of combat aircraft which is carried out with and/or against computer-generated forces, and the implementation takes place by the integration of the crew in virtual scenarios with virtual partners, targets and enemies in the usual cockpit and display environment.

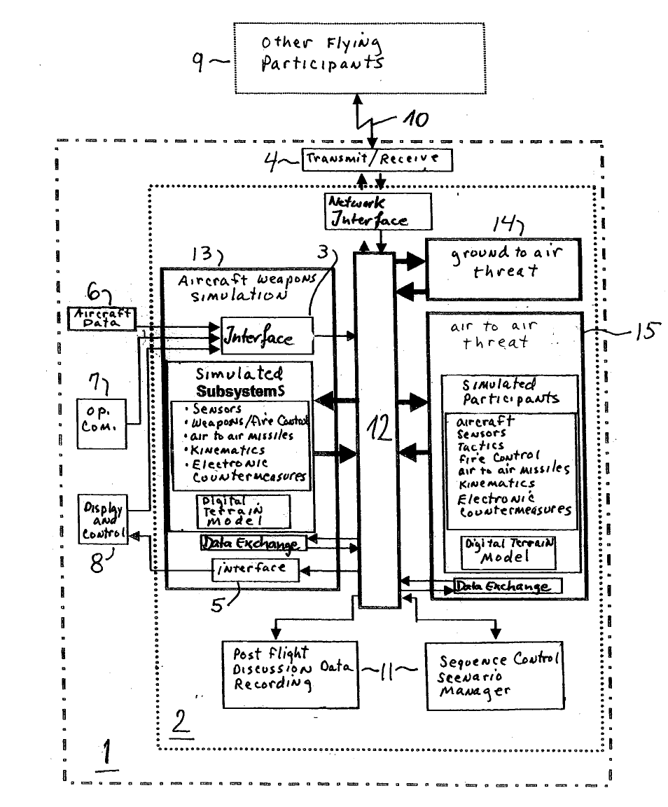

### BACKGROUND AND SUMMARY OF THE INVENTION

This application claims the priority of German patent document 102 16 599.8, filed Apr. 15, 2002 (15.04.2002), the disclosure of which is expressly incorporated by reference herein.

The invention relates to an autonomous weapons system simulation system for generating and displaying virtual scenarios on board and in flight.

Weapons system simulation systems are known in ground-bound full-mission simulators. Manufacturers of such full-mission simulators are far advanced with respect to the simulation of reality. The disadvantage of these known simulation systems, however, lies in their limited ability to display the effects and demands on a crew during a highly dynamic flight mission (first, during air defense tasks; later, in all types of missions of a modern air war). A ground simulator, that is, cannot replace actual flying, and cannot meet the requirements of an efficient training during actual flying.

It is an object of the invention to provide an autonomous weapons system simulation system for generating and displaying virtual scenarios on board and in flight.

This and other objects and advantages are achieved by the weapons simulation system according to the invention, which permits virtual real-time in flight air combat training on board a combat aircraft, which is carried out against or by means of computer-generated forces. According to the invention, the crew is integrated in virtual air defense scenarios with virtual friendly forces or simulation participants, targets and/or opponents in the usual cockpit and display environment. The virtual friendly forces, targets and opponents, which have a realistic behavior, can be detected and fought by means of sensors and weapons simulated and stimulated on board.

The invention advantageously permits more efficient instruction and training with respect to all air defense tasks, by an autonomous instruction available on board at any time in air-supported scenarios, ranging from the limited combat ready instruction in the operational unit to instruction during the mission at the site. The instruction can advantageously be achieved in scenarios simulated on board against multiple virtual enemies with air-to-air and ground-to-air threats, simulated weapons and weapons effects, electronic protective measures and countermeasures in their operational sensor environment simulated and stimulated on board, and a possible linkage with other carriers for the weapons system simulation in flight (hereinafter called weapons system simulation system or “WSSS”) in the air and/or on the ground.

Other objects, advantages and novel features of the present invention will become apparent from the following detailed description of the invention when considered in conjunction with the accompanying drawings.

### BRIEF DESCRIPTION OF THE DRAWINGS

The figure is a block diagram of a weapons system simulation system according to the invention.

### DETAILED DESCRIPTION OF THE DRAWINGS

The weapons system simulation system 1 comprises a computer, which is integrated into the existing on-board avionics environment or an on-board computer unit 2. The computer receives input data via an interface 3 and an air-to-air/air-to-ground, ground-to-air transmitting/receiving system 4, and outputs information for the crew via an on-board interface 5. By way of a shared memory 12, it also outputs information to a post-flight discussion system 11 and to a sequence control 11.

The input data comprise airplane real-time data 6, operating commands 7 for the WSSS, control functions 11 for the WSSS from the sequence control 11 as well as data obtained via the air-to-air/air-to-ground/ground-to-air transmitting/receiving system 4 from other flying WSSS participants 9 or simulation participants, such as enemies, partners or threats, or from ground-bound simulators and devices.

The output data are emitted on board on the on-board display and control system 8 and are sent to the other flying WSSS participants 9 or ground-bound simulators or devices, by way of the air-air/air-to-ground/ground-to-air transmitting/receiving system 4.

For the communication with the other flying WSSS participants 9 or ground-bound simulators and devices, a wireless high-speed data connection 10 is used.

Additional output data, processed for a subsequent analysis of the mission, are filed by the computer 2 in various data memories 11. These are flight and measuring data and data of a scenario manager.

The computer 2 is configured with its hardware and software in such a manner that three main programs for the simulation of the aircraft's own weapons system 13, the computer-generated air-to-air threat 15 and the computer-generated ground-to-air threat 14 run in parallel. For this purpose, the computer 2 is equipped with a shared memory 12.

The above-described on-board system can perform the following functions:

simulation of the method of operation, control and effect of on-board and opposing real and simulated sensor systems;

simulation of virtual opponents with adaptable tactical behaviors and a selectable topology;

generation of exercise and mission scenarios with the integration of all WSSS carriers;

simulation of the characteristics of the aircraft's own and opposing weapons, the weapons effect and the effectiveness of the weapons;

simulation of the opposing weapons use logic for missions outside and inside the visual range;

simulation of interactions in the case of emissions and disturbances with respect to all of the aircraft's own and opposing real and simulated on-board and ground systems;

simulation of a threat by ground systems; and

simulation of the aircraft's own survivability and that of opposing aircraft.

Furthermore, the on-board system has an automatic data recording system with scenario input and output possibilities for the particular mission and the possibility of a post-flight discussion of the instruction and training mission.

The air-to-air/air-to-ground/ground-to-air linking of the WSSS aircraft with ground-supported simulators and devices permits instruction and training while taking into account the Air Command and Control System (ACCS), the new C² system of NATO.

The man-machine interface of the on-board system may optionally be a helmet-mounted display (HMD) in order to be able to display virtual targets in the visual range of the crew.

The on-board system is supplemented by the integration of ground devices for the implementation of mission preparations and post-mission discussions, which can communicate with the on-board system by way of the above-mentioned input and output units.

The computer 2 can be equipped with another main program (not shown) which, by way of either the on-board systems 6, a transmitting/receiving device or the air-to-air/air-to-ground/ground-to-air transmitting receiving system 4, observes the simulation space for penetrating flying systems which are not participating in the simulation and, when such an event occurs, automatically terminates the simulation with the output of a corresponding warning message to the crew.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An autonomous weapons system simulation system for generating and displaying virtual scenarios on board an aircraft with a simulation of the aircraft's own weapons systems and computer-generated ground-to-air and air-to-air threats, wherein:
the weapons system simulation system permits a real-time air combat training on board of combat aircraft, which is carried out with and/or against computer-generated forces; and
the crew is integrated in virtual scenarios with virtual partners, targets and enemies, in an aircraft's cockpit and display environment.

2. The autonomous weapons system simulation system according to claim 1, comprising:
an air-to-air/air-to-ground/ground-to-air transmitting/receiving system through which input data are supplied to the weapons system simulation system;
an on-board interface through which information is communicated to the crew; and
a shared memory by which information is emitted to a post-flight discussion system and to a sequence control.

3. The autonomous weapons system simulation system according to claim 1, in which the simulation system is supplemented by ground devices which permit mission preparation, monitoring and analysis.

4. The autonomous weapons system simulation system according to claim 1, wherein:
the simulation system has a main program which observes the simulation space to detect penetration by flying systems that are not participating in the simulation; and
when such penetration occurs, the program automatically terminates the simulation with the output of a corresponding warning message to the crew.

5. The autonomous weapons system simulation system according to claim 2, wherein the on-board communication of data to the crew is performed at least partly via a helmet-mounted display.

6. An autonomous on-board aircraft weapons simulation system, comprising:
a first on-board computer program which simulates weapons systems of said aircraft and effects thereof during an actual operation of said aircraft;
a second on-board computer program which simulates threats to said aircraft in the form of opposing aircraft borne and ground based weapons during an actual operation of said aircraft;
a third on-board computer program which integrates a crew of said aircraft into virtual scenarios with virtual friendly aircraft, targets and enemy weapons in an aircraft cockpit and display environment, according to simulations generated by said first and second programs.

7. The simulation system according to claim 6, wherein simulation data are communicated to and from other aircraft participants in a joint exercise, which other aircraft are integrated into a joint in-flight weapons simulation.

8. A method of in-flight weapons training, comprising:
providing a first computer generated simulation of weapons carried aboard an aircraft and effects thereof;
providing a second computer generated simulation of threats to said aircraft in the form of opposing aircraft borne and ground based weapons;
detecting operating parameters of said aircraft during an actual flight operation thereof;
providing a virtual image display of said first and second simulations to a crew of said aircraft during said actual flight operation thereof, based on said operating parameters of said aircraft; and
integrating said crew of said aircraft into virtual scenarios with virtual friendly aircraft, targets and enemy weapons in said virtual image display.

9. The method according to claim 8, wherein said simulations take into account actual flight parameters for other aircraft participants in a joint in-flight weapons simulation exercise.
